(19) United States
(12) Patent Application Publication
(10) Pub. No.: US 2012/0158271 A1
(43) Pub. Date: Jun. 21, 2012

(54) METHOD FOR OPERATING AN INTERNAL COMBUSTION ENGINE

(76) Inventors: Klaus Joos, Walheim (DE); Werner Hess, Stuttgart (DE); Holger Rapp, Ditzingen (DE); Haris Hamedovic, Moeglingen (DE); Harry Friedmann, Vaihingen An Der Enz (DE); Andreas Koch, Loechgau (DE); Ruben Schlueter, Stuttgart (DE); Christoph Heisen, Muenchen (DE); Christian Reschke, Leonberg (DE); Joerg Koenig, Stuttgart (DE); Stephanie Wirth, Stuttgart (DE); Achim Hirchenhein, Trierweiler (DE)

(21) Appl. No.: 13/323,356

(22) Filed: Dec. 12, 2011

(30) Foreign Application Priority Data
Dec. 17, 2010 (DE) 102010063380.1

(51) Int. Cl. F02D 41/26; F02D 41/30

(52) U.S. Cl. 701/104; 701/103; 701/105

(57) ABSTRACT

A method for operating an internal combustion engine, in particular, of a motor vehicle. The internal combustion engine includes an injector having a nozzle needle for injecting fuel into a combustion chamber of the internal combustion engine, as well as an output stage component. A desired signal is specified for a lift characteristic of the nozzle needle. The injector is activated by the output stage component. A lift signal is ascertained that corresponds to the actual lift characteristic of the nozzle needle. An actual signal is ascertained from the lift signal. A deviation signal is ascertained in response to a deviation of the actual signal from the desired signal.

### CROSS REFERENCE

The present application claims the benefit under 35 U.S.C. §119 of German Patent Application No. DE 102010063380.1 filed on Dec. 17, 2010, which is expressly incorporated herein by reference in its entirety.

### FIELD OF THE INVENTION

The present invention relates to a method for operating an internal combustion engine.

### BACKGROUND INFORMATION

By activating a conventional injector for injecting fuel, e.g., a solenoid injector or piezoelectric injector, a nozzle needle is moved that opens or closes the injector for injecting fuel into a combustion chamber of the internal combustion engine.

German Patent Application No. DE 10 2007 038 512 A1 describes an actual current characteristic of a solenoid actuator of an injector over time may be compared to a desired current characteristic, and that a deviation criterion is calculated from the comparison. An instance of non-opening of the injector is detected, when the deviation criterion lies in a predefined range of values.

German Patent Application No. DE 10 2009 002 593 A1 describes a control duration of the actuator is calculated as a function of a setpoint value for an opening duration of the injector.

By taking into account the opening duration of the injector in place of solely the control duration, more precise metering of the fuel to be injected is rendered possible.

German Patent Application No. DE 10 2009 002 483 describes a method in which a variable characterizing an acceleration of a moving component of a solenoid actuator is calculated as a function of at least one electrical operating variable of the solenoid actuator. An operating state of the injector is deduced as a function of the variable characterizing the acceleration.

### SUMMARY

Features used in accordance with the example embodiments of the present invention are described below and shown in the drawings, whereby the features may be used in accordance with the present invention both by themselves and in different combinations, without making explicit reference to this again.

By ascertaining a deviation signal that indicates a deviation of an actual signal from a desired signal of an injection, an injection may be diagnosed in such a manner, that consequently, even small errors in the injection may be detected. Thus, the example method in accordance with the present invention may ensure that an injection or a plurality of injections are carried out as stipulated during calibration.

In a particularly advantageous manner, the example method may be used to diagnose short opening durations of the injector, during which only a small amount of fuel is metered. In the case of short opening durations, in particular, component part tolerances have a greater effect on the injection performance than in the case of longer opening durations. An example of such behavior is an injector, which does have a normal performance at longer desired opening durations, i.e., no deviation of the actual opening duration from the desired opening duration, but has a deviation, or does not open at all, at short desired opening durations.

The legislature requires monitoring of the individual injections or injection pattern generated during a cold start of the internal combustion engine. During a cold start of the combustion engine, the efficiency of the combustion engine is usually reduced artificially, in order to reach an operating temperature of a catalytic converter of an exhaust system of the internal combustion engine as rapidly as possible. The example method and the determination of the deviation signal advantageously allow the driver of the motor vehicle to be informed that a reduction, e.g., of the cold-start emissions, is not being correctly implemented, and that the motor vehicle must undergo maintenance. In an equally advantageous manner, the method allows the ascertained deviation signal to be supplied to other functions, such as control or regulating units, in order to improve the operation of the internal combustion engine.

Additional features, uses and advantages of the present invention are derived from the description below of exemplary embodiments of the present invention, which are illustrated in the figures. In this context, all of the described or illustrated features form the subject matter of the present invention, either alone or in any combination, irrespective of their combination in the description or in the figures, respectively. In all of the figures, as well as in different specific embodiments, the same reference characters are used for functionally equivalent variables.

### BRIEF DESCRIPTION OF THE DRAWINGS

Below, exemplary embodiments of the present invention are explained with reference to the figures.

FIG. 1 shows a schematic view of a gasoline engine having direct injection via an injector.

FIG. 2 shows a schematic timing diagram including the characteristic curve of a control signal, an electrical signal, a lift signal and an actual signal of an injection pattern.

FIGS. 3 and 4 show in each instance, a schematic timing diagram having the characteristic curve of the actual signal and a desired signal of an injection pattern.

FIG. 5 shows a schematic block diagram.

### DETAILED DESCRIPTION OF EXAMPLE EMBODIMENTS

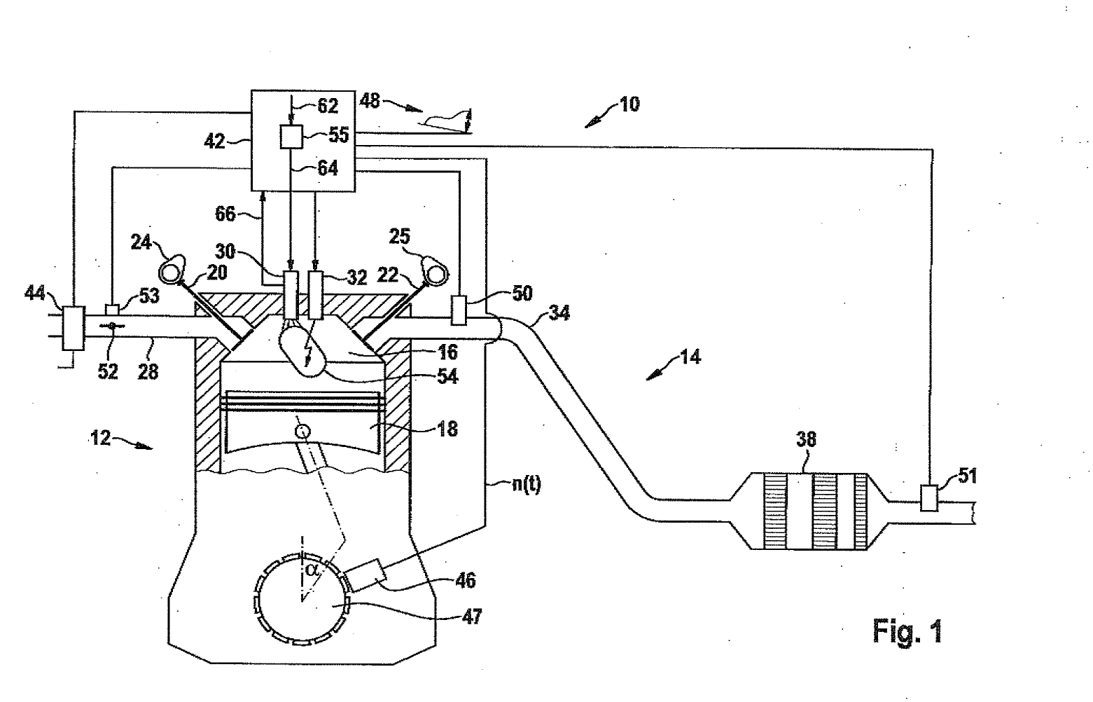

In FIG. 1, the numeral 10 refers to a general view of a direct-injection gasoline engine 12 having an exhaust system 14. Internal combustion engine 12 has a combustion chamber 16, which is movably sealed by a piston 18. The exchange of the charge of combustion chamber 16 is controlled via an intake valve 20 and an exhaust valve 22. Intake valve 20 is actuated by an intake valve actuator 24, and exhaust valve 22 is actuated by an exhaust valve actuator 25. Both intake valve actuator 24 and exhaust valve actuator 25 may be implemented by cam shafts as mechanical actuators, as well as by electrical, electrohydraulic or electropneumatic actuators.

When intake valve 20 is open, piston 18 draws air in from an intake manifold 28. During the suction operation and/or during the subsequent compression operation, fuel is metered directly into combustion chamber 16 via an injector 30. Injector 30 includes a nozzle needle, to which a lift is applied for the injection of fuel, in order to supply fuel to combustion chamber 16. The resulting, combustible fuel-air mixture in combustion chamber 16 is ignited by a spark plug 32. When exhaust valve 22 is opened, the combusted, residual gases are discharged from combustion chamber 16 into exhaust system 14. Exhaust system 14 has an exhaust pipe 34, which leads to a catalytic converter 38.

The control of internal combustion engine 12 is carried out by a control unit 42, which processes, for example, signals of an air-mass flow meter 44, an RPM sensor 46 that interacts with a signal-generating wheel 47, and a driver-input sensor 48. RPM sensor 46 ascertains an angular position α, which is transmitted to control unit 42. In addition, control unit 42 may be supplied with signals of a first exhaust-gas sensor 50, signals of a second exhaust-gas sensor 51 and signals of further sensors not shown, regarding pressures and/or temperatures in the region of internal combustion engine 12 or exhaust system 14. From these input signals and, possibly, further input signals, control unit 42 forms control signals, with the aid of which internal combustion engine 12 may be operated in accordance with the driver input and/or in accordance with pre-programmed requirements.

Thus, for example, in homogeneous operation of the combustion engine, the fuel-air mixture of a combustion chamber 16 may be adjusted via the position of a throttle valve 52, which is actuated by a throttle-valve actuator 53. In homogeneous operation, the torque generated by internal combustion engine 12 is determined mainly by the fuel-air mixture and the selected ignition firing point. However, in stratified operation, internal combustion engine 12 runs substantially unthrottled with an open throttle valve 52 and maximum charging of combustion chamber 16 with air. In this case, the torque generated by internal combustion engine 12 is determined generally by the injected mass of fuel and the ignition firing point. FIG. 1 qualitatively represents a stratified operation of internal combustion engine 12, in which a zone 54 having a combustible fuel-air mixture is produced by injecting a mass of fuel via injector 30. Inside combustion chamber 18, this zone 54 is surrounded by air and is ignited by a spark plug 32.

The method described below is not limited to gasoline engines having direct injection, but may also be applied to diesel engines or internal combustion engines having intake-manifold injection. Injector 30 may be manufactured, for example, as a solenoid injector or as a piezoelectric injector.

To activate injector 30, output stage component 55 receives a control signal 62, which determines an opening or a closing of injector 30. Control signal 62 is a digital signal. A rising edge of control signal 62 corresponds to a triggering of injector 30 to open, a falling edge of control signal 62 corresponds to a triggering of injector 30 to close.

Output stage component 55 generates an electrical signal 64 in accordance with control signal 62, the electrical signal 64 being either a voltage U or a current I. Using electrical signal 64, an actuator of injector 30 is energized by output stage component 55 so as to induce an injection of fuel. The action of injector 30 may be reflected in electrical signal 64, and in this case, e.g., the opening time and the closing time of injector 30 may be determined from electrical signal 64. Electrical signal 64 is measured by control unit 42.

A lift signal 66 is picked off at injector 30. Lift signal 66 corresponds to an actual stroke that the nozzle needle of injector 30 executes. The characteristic curve of lift signal 66 is generally referred to as a lift characteristic. As indicated in FIG. 1, an actual signal 60 of the lift characteristic of the nozzle needle of injector 30 is ascertained from the lift signal 66 generated by injector 30. Alternatively, actual signal 60 may also be derived from electrical signal 64.

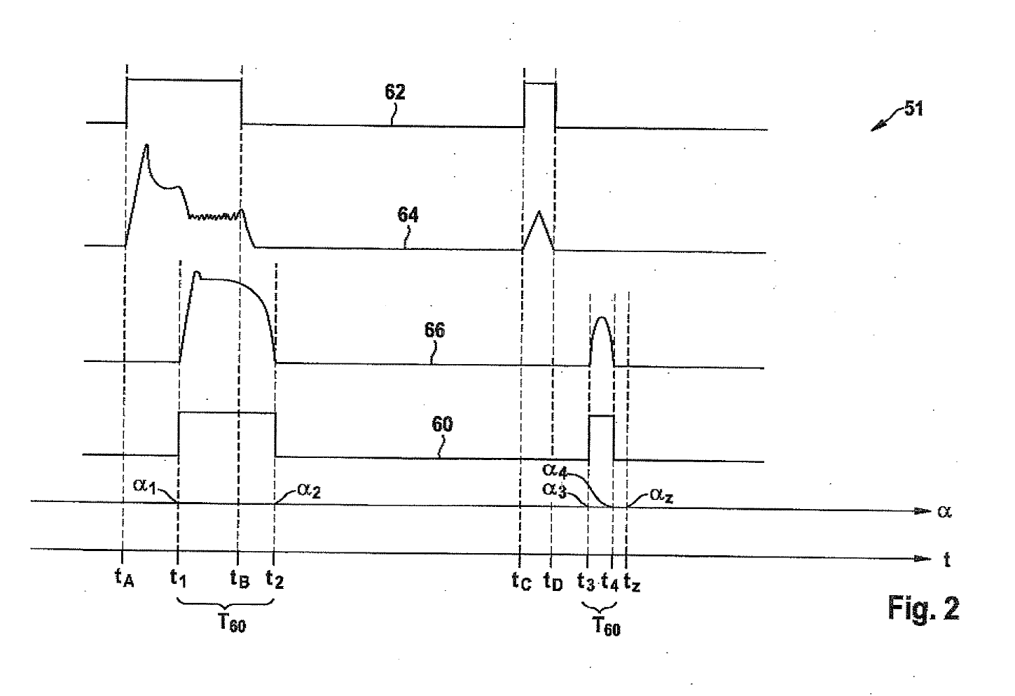

A speed signal n(t) is ascertained by RPM sensor 46 and supplied to control unit 42. Control unit 42 ascertains the characteristic curve of actual signal 60, which is shown by way of example in FIGS. 2, 3 and 4.

FIG. 2 shows, by way of example, a schematic timing diagram 51 including the characteristic curves of control signal 62, electrical signal 64, lift signal 66 and actual signal 60. Times t₁, t₂, t₃, t₄, t_{A}, t_{B}, t_{C}, t_{D} and an ignition firing point t_{z} are plotted on a time axis t. Spark plug 32 is fired at ignition firing point t_{z}. In addition, angles α₁, α₂, α₂, α₃, α₄ and an ignition angle α_{z} are plotted, spark plug 32 being fired at ignition angle α_{z}. The position of the injections and the ignition according to actual signal 60 is controlled by control unit 42. The position of the injections and ignitions in FIGS. 2, 3 and 4 is exemplary and may be used for heating up catalytic converter 38.

Control signal 62 in FIG. 2 increases at time t_{A}, which corresponds to a rising edge, and decreases at time tₛ, which corresponds to a falling edge. Control signal 62 rises at time t_{C} and falls at time tᵢₚ. In accordance with control signal 62, injector 30 is activated between times t_{A} and t_{B}, so as to inject fuel. In accordance with control signal 62, a further, second activation of injector 30 is provided between times t_{C} and t_{D}. The activation of injector 30 takes place with the aid of electrical signal 64, which is generated by output stage component 55 and is supplied to injector 30.

The characteristic curve of lift signal 66, which shows the lifting of the nozzle needle from its seat and, therefore, an opening of the injector, results from the activation of injector 30 in accordance with the characteristic curve of electrical signal 64. Actual signal 60, which indicates either the closed state or the open state of injector 30, is determined from the characteristic curve of lift signal 66 or from parts of the characteristic. Consequently, actual signal 60 is ascertained from an actual lift characteristic of the nozzle needle.

Actual signal 60 in FIG. 2 increases at time t₁, which corresponds to a rising edge, and decreases at time t₂, which corresponds to a falling edge. Actual signal 60 rises at time t₃ and falls at time t₄. In accordance with actual signal 60, a first injection begins at time t₁ and ends at time t₂. In accordance with actual signal 60, a second actual injection begins at time t₃ and ends at time t₄. After execution of the first and second injections, the fuel-air mixture in the combustion chamber is ignited at ignition firing point t_{z}.

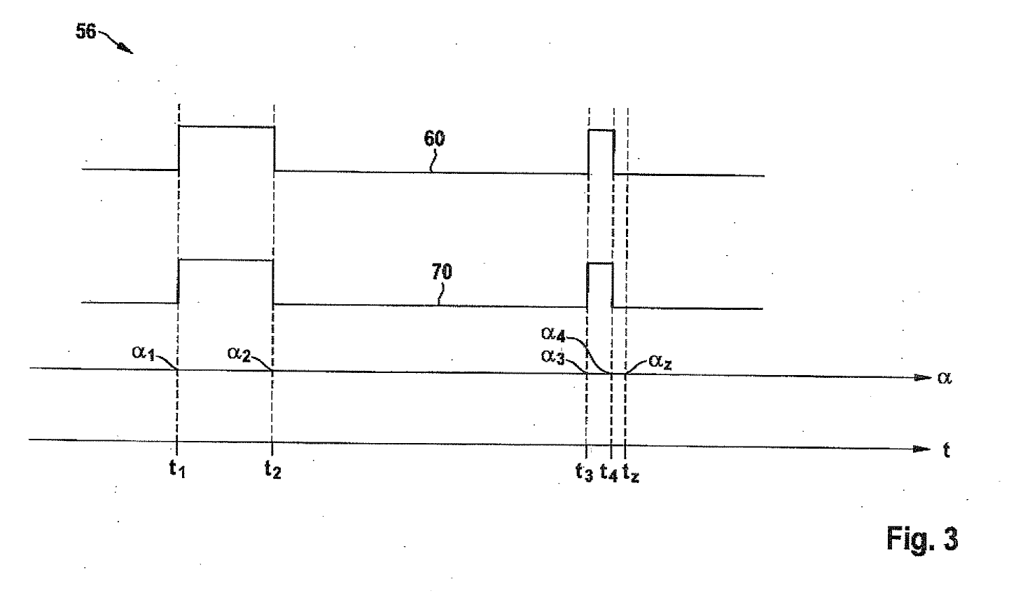

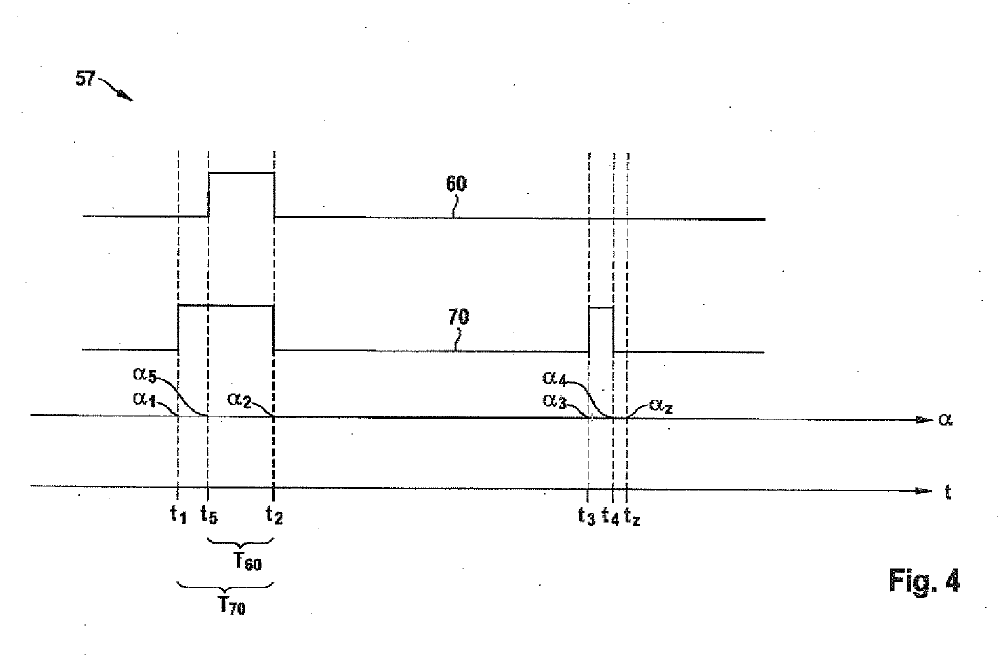

FIGS. 3 and 4 show, by way of example, schematic timing diagrams 56, 57 including the characteristic of actual signal 60 and a desired signal 70 of an injection pattern. Desired signal 70 for the lift characteristic of the nozzle needle of the injector is specified. Times t₁, t₂, t₃, t₄ and ignition firing point t_{z} are plotted on a time axis t.

Control signal 62 may be generated as a function of desired signal 70. Desired signal 70 in FIGS. 3 and 4 is used to monitor or diagnose actual signal 60 and, therefore, to detect deviations of the actual lift characteristic of the nozzle needle, i.e., of actual signal 60, from the desired lift characteristic of the nozzle needle, i.e., from desired signal 70.

Desired signal 70 may be specified by initially storing a desired lift characteristic that is determined one time, e.g., during calibration, and fetching it out as required; or desired signal 70 may be specified by ascertaining desired signal 70 from control signal 62.

Actual signal 60 in FIG. 3 increases at time t₁, which corresponds to a rising edge, and decreases at time t₂, which corresponds to a falling edge. Actual signal 60 rises at time t₃ and falls at time t₄. In accordance with actual signal 60, a first injection begins at time t₁ and ends at time t₂. In accordance with actual signal 60, a second actual injection begins at time t₃ and ends at time t₄. After execution of the first and second injections, the fuel-air mixture in the combustion chamber is ignited at ignition firing point t_{z}.

Desired signal 70 in FIG. 2 substantially coincides with actual signal 60, which is why no deviation of actual signal 60 from desired signal 70 results. Desired signal 70 is specified, in order to monitor actual signal 60 for a deviation from desired signal 70. Actual signal 60 and desired signal 70 may relate to one or more injections. If actual signal 60 and desired signal 70 relate to a plurality of injections, then the characteristic curves relate to an injection pattern. With regard to a single injection, a deviation of actual signal 60 from desired signal 70 of this injection already signifies a deviation for the injection pattern.

In FIGS. 3 and 4, desired signal 70 includes a first desired injection between times t₁ and t₂ and a second desired injection between times t₃ and t₄. A tolerance range regarding the deviation of actual signal 60 from desired signal 70 may be provided, so that a deviation is first ascertained in response to the tolerance range being exceeded or not being reached.

As shown in FIGS. 3 and 4, actual signal 60 and desired signal 70 are associated with an angular position α of the internal combustion engine. This relationship of actual signal 60 and desired signal 70 with angular position α may allow an injection or an injection pattern to be monitored for a deviation, and an error or a deviation of actual signal 60 to be detected.

FIG. 4 schematically shows timing diagram 57, which includes actual signal 60 and desired signal 70. Regarding the first desired injection, actual signal 60 differs from desired signal 70 in that the actual injection does not begin at time t₁, but at a later time t₅ between times t₁ and t₂. Regarding the second desired injection, actual signal 60 runs on the same level between times t₃ and t₄ as before and after times t₃ and t₄. Therefore, with regard to the second desired injection, actual signal 60 corresponds to an instance of non-opening of the injector, which means that a deviation results. Regarding the second desired injection, a desired state differs from an actual state, the actual state and the desired state relating to an instance of opening and an instance of non-opening of the injector. In the case of the second desired injection of FIG. 4, the desired state relates to the opening of the injector, and the actual state relates to the non-opening of the injector.

In FIG. 4, with regard to the first desired injection, an actual opening duration T₆₀ and a desired opening duration T₇₀ are also shown. Opening duration T₆₀ begins at time t₅ and ends at time t₂. Desired opening duration T₇₀ begins at time t₁ and ends at time t₂. If actual opening duration T₆₀ differs from desired opening duration T₇₀, then this difference indicates a deviation.

An opening time generally corresponds to the time having a rising edge, and a closing time generally corresponds to the time having a falling edge. In general, an actual opening duration T₆₀ begins at an actual opening time and ends at an actual closing time. In general, a desired opening duration T₇₀ begins at a desired opening time and ends at a desired closing time.

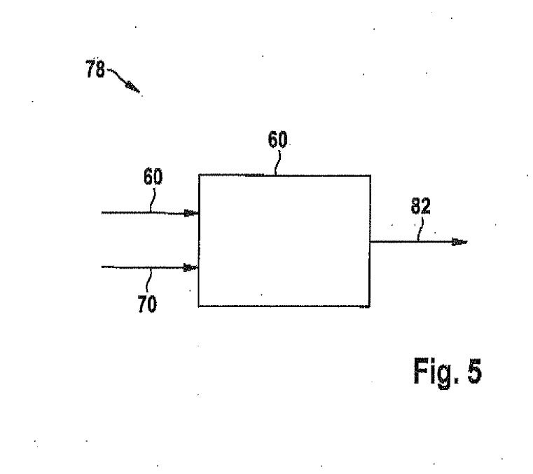

FIG. 5 schematically shows a block diagram 78 having a block 80. Actual signal 60 and desired signal 70 are supplied to block 80. Block 80 generates a deviation signal 82 as a function of actual signal 60 and desired signal 70, if a deviation between actual signal 60 and desired signal 70 occurs. Actual signal 60 and desired signal 70 may be ascertained in relation to angular position α. According to FIG. 3 and timing diagram 56, block 80, for example, does not generate a deviation signal 82, or block 80 determines the value of deviation signal 82 to be zero and therefore does not indicate a deviation. When actual signal 60 and desired signal 70 of FIG. 4 or the corresponding, individual characteristics of the injections are supplied, block 80 generates, for example, a deviation signal 82, or block 80 determines the value of deviation signal 82 to be one and consequently indicates a deviation.

With the aid of deviation signal 82, the driver of the motor vehicle may be informed that a desired injection was not executed correctly. This may occur in a form in which the driver is informed that, due to exhaust gas emissions that are too high, the motor vehicle must be driven to a garage for maintenance. Deviation signal 82 may also be supplied to other control and regulating units of control unit 42, in order to improve the injection process and, consequently, the operation of the internal combustion engine.

The methods described above may be represented as a computer program for a digital computing element. The digital computing element suitable for executing the above-described methods as a computer program. The internal combustion engine 12 for, in particular, a motor vehicle, includes control unit 42, which includes the digital computing element, in particular, a microprocessor. Control unit 42 includes a storage medium on which the computer program is stored.

What is claimed is:

1. A method for operating an internal combustion engine of a motor vehicle, the internal combustion engine having an injector having a nozzle needle for injecting fuel into a combustion chamber of the internal combustion engine, and the internal combustion engine having an output stage component for activating the injector, the method comprising:
specifying a desired signal for a lift characteristic of the nozzle needle;
activating the injector by the output stage component;
ascertaining a lift signal that corresponds to an actual lift characteristic of the nozzle needle;
ascertaining an actual signal from the lift signal; and
ascertaining a deviation signal from the actual signal and the desired signal.

2. The method as recited in claim 1, further comprising:
ascertaining an angular position of the internal combustion engine, wherein the desired signal and the actual signal are ascertained in relation to the angular position.

3. The method as recited in claim 1, wherein the injector is controlled using an injection pattern made up of a plurality of injections, and a deviation of the actual signal from the desired signal of the injection pattern is characterized by a difference between the actual signal and the desired signal of at least one of the injections.

4. The method as recited in claim 3, wherein the actual signal includes an actual number of injections, the desired signal includes a desired number of injections, and the deviation is characterized by a difference between the actual number and the desired number.

5. The method as recited in claim 1, wherein the deviation signal is first ascertained in response to exceeding of a tolerance range regarding a deviation of the actual signal from the desired signal.

6. The method as recited in claim 1, wherein the actual signal includes an actual opening time, and the desired signal includes a desired opening time, and a deviation is characterized by a difference between the actual opening time and the desired opening time.

7. The method as recited in claim 1, wherein the actual signal includes an actual closing time and the desired signal includes a desired closing time, and a deviation is characterized by a difference between the actual closing time and the desired closing time.

8. The method as recited in claim 1, wherein the actual signal includes a first injection amount of the injector, and the desired signal includes a desired injection amount of the injector, and the deviation is characterized by a difference between the actual injection amount and the desired injection amount.

9. A memory device storing a computer program, the computer program being for operating an internal combustion engine of a motor vehicle, the internal combustion engine having an injector having a nozzle needle for injecting fuel into a combustion chamber of the internal combustion engine, and the internal combustion engine having an output stage component for activating the injector, the computer program, when executed by a control unit, causing the control unit to perform the steps of:
specifying a desired signal for a lift characteristic of the nozzle needle;
activating the injector by the output stage component;
ascertaining a lift signal that corresponds to an actual lift characteristic of the nozzle needle;
ascertaining an actual signal from the lift signal; and
ascertaining a deviation signal from the actual signal and the desired signal.

10. A control unit for an internal combustion engine for a motor vehicle, the control unit being equipped with a digital computing element, the internal combustion engine having an injector having a nozzle needle for injecting fuel into a combustion chamber of the internal combustion engine having an output stage component for activating the injector, the digital computing element configured to specify a desired signal for a lift characteristic of the nozzle needle, activate the injector by the output stage component, ascertain a lift signal that corresponds to an actual lift characteristic of the nozzle needle, ascertain an actual signal from the lift signal, and ascertain a deviation signal from the actual signal and the desired signal.
